(19) United States
(12) Patent Application Publication
(10) Pub. No.: US 2012/0094599 A1
(43) Pub. Date: Apr. 19, 2012

(54) ANTENNA DEVICE AND PORTABLE WIRELESS APPARATUS PROVIDED WITH SAME

(75) Inventor: Kazuhiko Takeyama, Ishikawa (JP)

(73) Assignee: PANASONIC CORPORATION, Osaka (JP)

(21) Appl. No.: 13/380,379

(22) PCT Filed: Mar. 4, 2010
(86) PCT No.: PCT/JP2010/001529

§ 371 Date: Dec. 22, 2011

(30) Foreign Application Priority Data
Jun. 30, 2009 (JP) 2009-155294

(51) Int. Cl. H04B 5/00

(52) U.S. Cl. 455/41.1

(57) ABSTRACT

An antenna unit of the present invention is an antenna unit that performs wireless communication utilizing induction coupling, the unit includes a loop antenna; a communication circuit section that is connected to the loop antenna in order to perform wireless communication utilizing induction coupling; a metallic plate provided outside or inside the loop antenna in a form of a loop by an openable and closable switch; and a detector that detects a receiving level of a wireless signal received by the loop antenna, wherein the communication circuit section controls opening and closing of the switch according to a receiving level of the wireless signal detected by the detector, thereby switching a state of the metallic plate between a closed looped state and an open non-looped state.

### TECHNICAL FIELD

The present invention relates to an antenna unit used in a mobile device, like an IC card of an RFID system, as well as relating to a portable wireless device equipped with the antenna unit.

### BACKGROUND ART

An RFID (Radio Frequency Identification) system is generally used for electronic money, or the like. Communication between a mobile device that acts as an RFID card or an RFID-containing device and its counterpart equipment [a reader/writer (R/W)] that is a stationary machine disposed in a shop, or the like, is performed through wireless communication utilizing induction coupling. A wireless communication technique utilizing induction coupling allows establishment of communication only within a range where a high degree of coupling exists between an antenna of the mobile device and an antenna of its counterpart equipment, and a communication distance is as short as about one meter. When transmission power of the counterpart equipment is high, an amplitude of a signal input to a communication circuit section of the mobile device becomes considerably large while the mobile device and its counterpart equipment remain in considerably close to each other.

FIG. 7 shows a section diagram of a related art RFID system. An antenna 41 of a mobile device 40 receives a radio wave transmitted from an antenna 31 of counterpart equipment 30, by means of electromagnetic induction coupling, and a received signal is input to a communication circuit section 43 by way of an antenna circuit section 42 (an LC resonance circuit section). When an amplitude of the received signal input to the communication circuit section 43 is large, the amplitude surpasses a rated withstand voltage of a transistor accommodated in a control IC of the communication circuit section 43, so that the communication circuit section 43 will become broken. For this reason, a clipping circuit 44 is additionally provided between the antenna circuit section 42 and the communication circuit section 43, thereby limiting the amplitude of the received signal input to the communication circuit section 43.

The clipping circuit 44 is implemented by use of: for instance, a diode, and shows a voltage-current characteristic, like that shown in FIG. 8. If an input voltage value of the clipping circuit 44 is large, an output current will suddenly increase, whereupon a resistance value of the clipping circuit 44 will decrease. Accordingly, an input voltage of the communication circuit section 43 can be reduced.

Incidentally, in the RFID system, a load modulation switch 45 provided in the antenna circuit section 42 of the mobile device 40 is turned on or off, thereby changing a resistance value of the antenna circuit section 42 and in turn changing a current value. A difference in electromagnetic induction thus develops in the antenna 41, which in turn effects communication from the mobile device 40 to the counterpart equipment 30. Therefore, when a resistance value of the clipping circuit 44 becomes smaller, a change in resistance value of the antenna circuit section 42 caused by activation or deactivation of the switch 45 also becomes smaller. Thus, the difference in electromagnetic induction becomes smaller, so that the counterpart equipment 30 can properly receive a radio wave transmitted from the mobile device 40. Specifically, there arises a Null phenomenon in which the mobile device 40 and the counterpart equipment 30 cannot establish communication while remaining in close to each other.

A hitherto proposed method for avoiding occurrence of the Null phenomenon involves a plurality of capacitors (condensers) and a voltage detection section that are provided in an IC control section of the mobile device. The voltage detection section detects a received voltage level of a signal received by an antenna after the signal has undergone rectification and smoothing. According to the thus-detected received voltage level, switching between the capacitors is carried out, to thus reduce an antenna gain (see; for instance, Patent Document 1). FIG. 9 shows an equivalent circuit of the related art mobile device shown in FIG. 7.

### RELATED ART DOCUMENT

### Patent Document

Patent Document 1: JP-A-2005-011009

### DISCLOSURE OF THE INVENTION

### Problem that the Invention is to Solve

However, there are generally a plurality of types of RFID counterpart equipment, and a resonance frequency varies from one counterpart equipment to another. As shown in FIG. 9, a detector 46 detects a received voltage level of a signal that has been received by the antenna 41 of the mobile device 40 and that has passed through the clipping circuit 44, and a capacitor 48 of the antenna circuit section 42 is switched. In this case, the resonance frequency of the mobile device 40 also changes. When the resonance frequency of the mobile device 40 is thus switched, a signal amplitude (gain) becomes smaller in some frequency bands. However, in other frequency bands, the signal amplitude becomes greater.

FIGS. 10(a) and 10(b) show a change in S21 characteristic induced by switching between the capacitors of the related art mobile device shown in FIG. 7. FIG. 10(a) shows an S21 characteristic of the mobile device exhibited in response to its counterpart equipment A. FIG. 10(b) shows an S21 characteristic of the mobile device in response to counterpart equipment B that differs from the counterpart equipment A. The S21 characteristic of the mobile device is a frequency response characteristic of a power gain between an output terminal of a communication circuit section of counterpart equipment (an input terminal of an antenna) and an input terminal of a communication circuit section of the mobile device (an output terminal of a detector of the mobile device). Switching between the capacitors of the mobile device results in a decrease in the gain of the mobile device in response to the counterpart equipment A as shown in FIG. 10(a) and an increase in the gain of the mobile device in response to the counterpart equipment B as shown in FIG. 10(b). Specifically, the related art mobile device cannot inhibit occurrence of the Null phenomenon in all of the plurality of types of counterpart equipment.

The object of the present invention is to provide an antenna unit capable of transmitting and receiving a wireless signal without involvement of occurrence of a Null phenomenon in a plurality of types of counterpart equipment that operate at different resonance frequencies and a portable wireless device having the antenna unit.

### Means for Solving the Problem

An antenna unit of the present invention that performs wireless communication utilizing induction coupling, the unit comprising: a loop antenna; a communication circuit section that is connected to the loop antenna in order to perform wireless communication utilizing induction coupling; a metallic plate provided outside or inside the loop antenna in a form of a loop by way of an openable and closable switch; and a detector that detects a receiving level of a wireless signal received by the loop antenna, wherein the communication circuit section controls opening and closing of the switch according to a receiving level of the wireless signal detected by the detector, thereby switching a state of the metallic plate between a closed looped state and an open non-looped state.

In the antenna unit, the metallic plate is provided on a same plane where the loop antenna is provided.

In the antenna unit, the metallic plate is a reader/writer antenna.

The antenna unit is built in a portable wireless device.

### ADVANTAGE OF THE INVENTION

The portable wireless device of the present invention and a portable radio equipped with the antenna unit can perform wireless communication with a plurality of types of counterpart equipment that operate at different resonance frequencies even when the portable wireless device comes close to the counterpart equipment, like an RFID system, without involvement of occurrence of a Null phenomenon.

### BRIEF DESCRIPTION OF THE DRAWINGS

FIG. 1 is a plan view showing an antenna unit 1 of a first embodiment of the present invention.

FIG. 2 is an equivalent circuit diagram of a mobile device equipped with the antenna unit 1 shown in FIG. 1.

FIG. 3 is a plot showing a change in S21 characteristic of the antenna unit 1 shown in FIG. 1.

FIG. 4 is a plan view showing an antenna unit 1A of a second embodiment of the present invention.

FIG. 5 is a plan view showing an antenna unit 1B of a third embodiment of the present invention.

FIG. 6 is an equivalent circuit diagram of a mobile device equipped with the antenna unit 1B shown in FIG. 5.

FIG. 7 is a section diagram showing a related art RFID system.

FIG. 8 is a plot of a voltage-current characteristic of a diode making up a clipping circuit of a mobile device of the RFID system shown in FIG. 7.

FIG. 9 is an equivalent circuit diagram of the related art mobile device shown in FIG. 7.

FIG. 10 (a) is a plot showing an S21 characteristic of the related art mobile device in response to counterpart equipment A; and FIG. 10 (b) is a plot showing an S21 characteristic of the related art mobile device in response to counterpart equipment B differing from the counterpart equipment A.

### EMBODIMENTS FOR IMPLEMENTING THE INVENTION

Embodiments of the present invention are hereunder described by reference to the drawings.

### First Embodiment

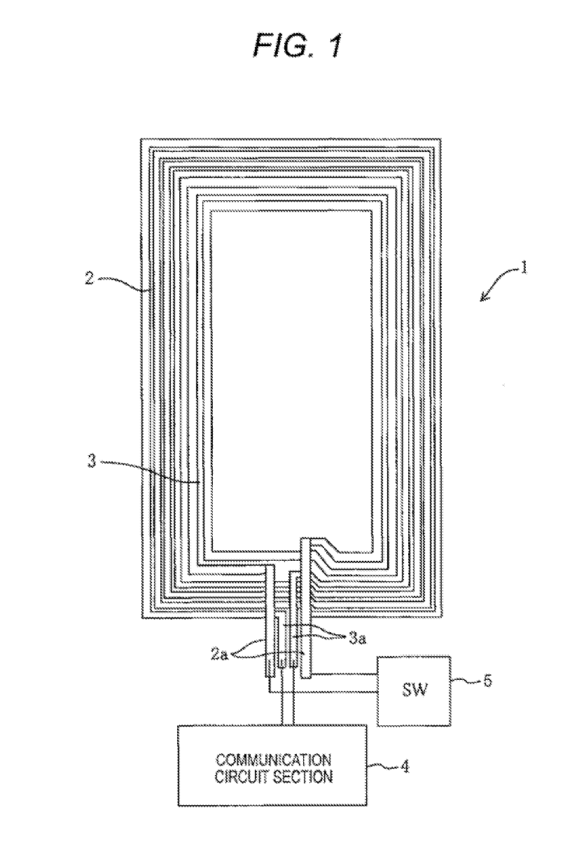

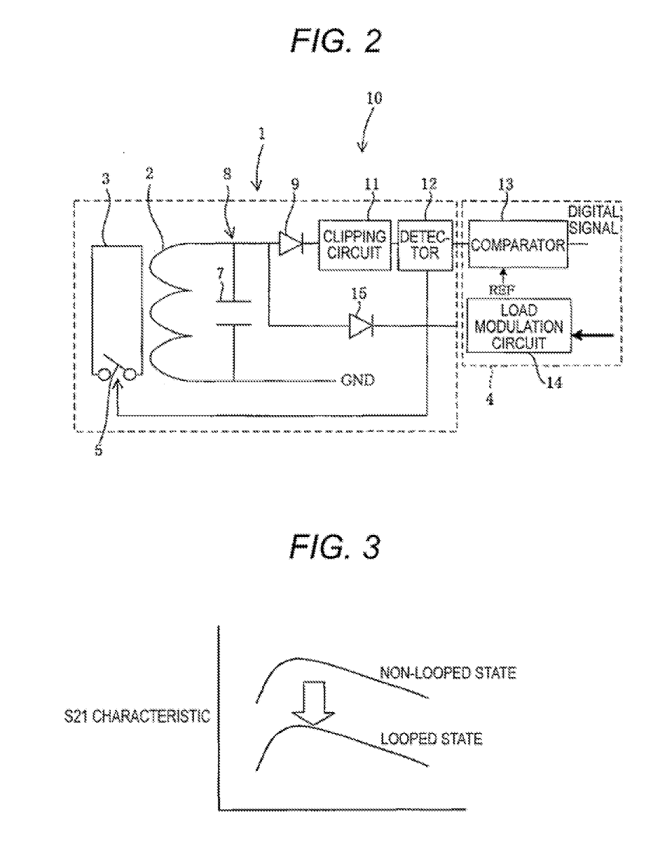

By reference to FIGS. 1 through 3, an antenna unit of a first embodiment of the present invention is described. FIG. 1 is a plan view of an antenna unit 1 of the first embodiment of the present invention. The antenna unit 1 shown in FIG. 1 has a loop antenna 2, a metallic plate 3, and a switch 5 interposed in the metallic plate 3. As shown in FIG. 1, a communication circuit section 4 is connected to the loop antenna 2 of the antenna unit 1. Further, as shown in FIG. 2, the antenna unit 1 has a detector 12 connected to the switch 5.

The loop antenna 2 is used; for instance, as a main antenna of a mobile device of an RFID system. In the present embodiment, the loop antenna 2 is made up of a four-turn rectangular loop made of copper foil, or the like. Both ends 2a of the loop antenna 2 are pulled outside of the metallic plate 3 from a center of a lower side of the rectangular shown in FIG. 1 and connected to the communication circuit section 4 of the mobile device.

The metallic plate 3 is used as a control antenna for controlling a gain of the loop antenna 2. As shown in FIG. 1, the metallic plate 3 is provided in the form of a loop within the same plane where the loop antenna exists, around the inside of the loop antenna 2 and is formed into a loop that is discontinuous at a position where open ends 3a are formed. The metallic plate 3 is formed from a two-turn rectangular loop made of copper foil, or the like. In accordance with a state of the switch 5 to be described later, the metallic plate 3 effects a transition between a looped state in which the metallic plate assumes a closed loop shape and a non-looped state in which the metallic plate becomes discontinuous at the open ends 3a and does not assume a perfectly closed loop shape.

The open ends 3a of the metallic plate 3 can be at any position on the metallic plate 3 formed into a loop shape.

The essential requirement for the metallic plate 3 is to be provided substantially in the same plane where the loop antenna 2 is provided. In addition to being provided in the same plane made by the loop antenna 2, the metallic plate 3 can also be provided while displaced by about one to two millimeters from the plane in the vertical direction. In the drawings, the open ends 3a of the metallic plate 3 are pulled outside the loop antenna 2 from the center of the lower side of the rectangular, and the switch 5 is interposed between the thus-pulled open ends 3a.

As will be described later, the switch 5 effects a transition between an open state and a closed state under control of the communication circuit section 4 according to a receiving level of a signal received by the loop antenna 2 detected by the detector 12. When the switch 5 is turned on and brought into a closed state, the open ends 3a of the metallic plate 3 are physically connected by way of the switch 5. In the meantime, when the switch 5 is turned off and brought into an open state, the open ends 3a of the metallic plate 3 are physically disconnected. Therefore, when the switch 5 is closed, the open ends 3a of the metallic plate 3 are electrically connected by way of the switch 5. However, when the switch 5 is in an open state, the open ends 3a are not electrically connected.

When the switch 5 is closed, the switch 5 electrically connects the open ends 3a of the metallic plate 3, whereupon the metallic plate 3 enters a looped state where the metallic plate is closed in the form of the loop. In the meantime, when the switch 5 is in an open state, the switch 5 does not make an electrical connection of the open ends 3a of the metallic plate 3. The metallic plate 3 enters a discontinuous non-looped state because of the open ends 3a.

FIG. 2 is an equivalent circuit of a mobile device 10 equipped with the antenna unit 1 shown in FIG. 1. The mobile device 10 is a portable wireless device, like an RFID card and an RFID-containing device, and includes a cell phone, or the like. In the mobile device 10, an antenna circuit section (an LC resonance circuit section) 8 is made up of the loop antenna 2 and a capacitor 7 (electrostatic capacitance) of the antenna 2. Control diodes 9 and 15 are connected in parallel to one end of the antenna circuit section 8. A clipping circuit 11, the detector 12, and a comparator 13 are connected in series to and in this sequence to one of the diodes 9. A load modulation circuit 14 is connected to the other diode 15. The other end of the antenna circuit section 8 is connected to a ground (GND). The switch 5 is connected to an output side of the detector 12. The switch 5 is controlled by the communication circuit section 4 and is turned on or off according to a level (a magnitude of an amplitude) of a voltage output from the detector 12 that is a receiving level of a signal received by way of the loop antenna 2.

The mobile device 10 receives a communication radio wave from un-illustrated counterpart equipment by means of the loop antenna 2. The diode 9 rectifies a received signal of a resonance frequency selected by the LC resonance circuit of the antenna circuit section 8. By means of the detector 12, the mobile device 10 detects a voltage of the received signal passed through the clipping circuit 11. The comparator 13 converts the signal output from the detector 12 into a digital signal with reference to an REF signal. A control section (not shown) of the communication circuit section 4 performs processing for decoding received data, or the like. In the meantime, according to a transmission data signal from the control section of the communication circuit section 4, a current value is changed by means of a change in resistance value of the load modulation circuit 14. A difference in induction voltage is developed in the loop antenna 2, thereby performing communication from the mobile device 10 to the counterpart equipment.

FIG. 3 shows a difference in S21 characteristic of the antenna unit stemming from switching of the switch 5. A vertical axis in FIG. 3 represents an S21 characteristic, and a horizontal axis in FIG. 3 represents a frequency [MHz]. As shown in FIG. 3, when the metallic plate 3 is in the non-looped state in which the metallic plate becomes discontinuous at the open ends 3a around the inside of the loop antenna 2, the S21 characteristic of the antenna unit 1 is not deteriorated by the frequency, and an antenna gain increases over an entire frequency band. For these reasons, the antenna unit 1 can be applied to the antenna section of the mobile device even in response to a plurality of types of counterpart equipment that operate at different resonance frequencies.

In the meantime, the switch 5 is turned on and brought into a closed state, whereby the metallic plate 3 assumes a completely closed looped state around the inside of the loop antenna 2. In this state, the gain of the antenna unit 1 decreases over the entire frequency band as shown in FIG. 3. Therefore, in a case where the antenna unit 1 performs wireless communication utilizing induction coupling; for instance, when the receiving level of the loop antenna 2 detected by the detector 12 is higher than a given value (an amplitude is large), the switch 5 is turned on under control of the communication circuit section 4. Thus, the metallic plate 3 assumes a completely closed looped state around the inside of the loop antenna 2, whereupon the gain of the antenna unit 1 decreases over the entire frequency band. Therefore, even when the antenna unit 1 of the present embodiment is applied to the antenna section of the mobile device 10 in response to the antenna section of the counterpart equipment and when the mobile device 10 is used in a short range from the counterpart equipment, communication can be carried out without involvement of occurrence of a Null phenomenon.

In the antenna unit 1 of the first embodiment, when the antenna unit 1 performs wireless communication utilizing induction coupling, the switch 5 is turned off under control of the communication circuit section 4 according to the receiving level of the loop antenna 2 detected by the detector 12. When the metallic plate 3 is in a non-looped state in which the metallic plate becomes discontinuous at the open ends 3a, around the inside of the loop antenna 2, the S21 characteristic of the antenna unit 1 can increase the gain over the entire frequency band. Therefore, the antenna unit 1 can be applied to the antenna section of the mobile device in response to a plurality of types of counterpart equipment that operate at different resonance frequencies.

In the antenna unit 1 of the first embodiment, when the antenna unit 1 performs wireless communication utilizing induction coupling; for instance, when the receiving level of the loop antenna 2 detected by the detector 12 is higher than a given level (an amplitude is high), the switch 5 is turned on under control of the communication circuit section 4. When the metallic plate 3 and the switch 5 are completely closed in the form of the loop around the inside of the loop antenna 2, the gain of the antenna unit 1 can be decreased over the entire frequency band. Therefore, even when the antenna unit 1 of the embodiment is applied to the antenna section of the mobile device 10 in response to the antenna section of the counterpart equipment and when the mobile device 10 is used in a short range from the counterpart equipment, communication can be performed without involvement of occurrence of the Null phenomenon.

### Second Embodiment

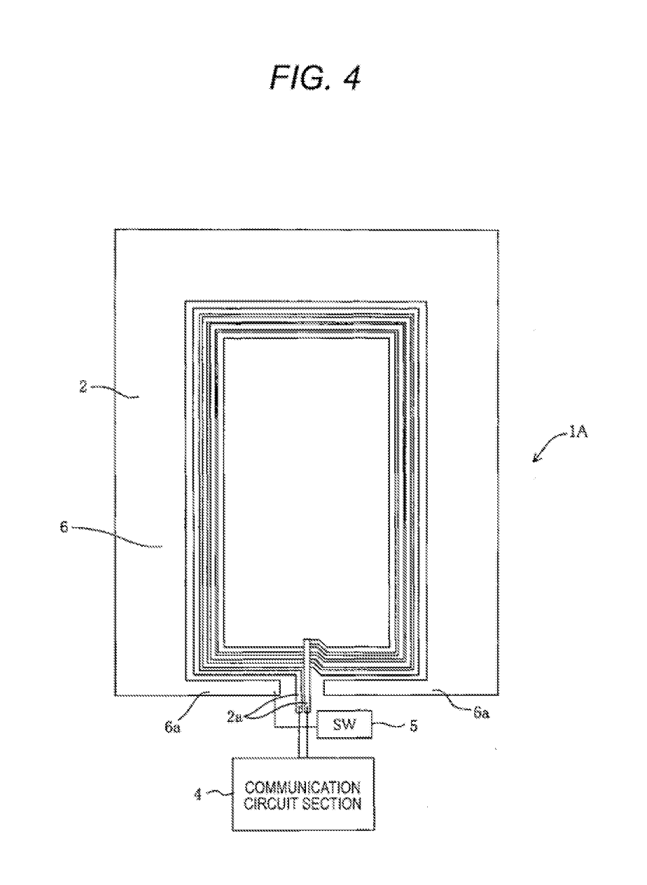

By reference to FIG. 4, an antenna unit 1A of a second embodiment of the present invention is now described. FIG. 4 is a plan view showing the antenna unit 1A of the second embodiment of the present invention. The antenna unit 1A shown in FIG. 4 includes the loop antenna 2 and a metallic plate 6 provided in the form of a loop outside the loop antenna 2. As shown in FIG. 4, the communication circuit section 4 is connected to the loop antenna 2 of the antenna unit 1A. Further, as in the case of the antenna unit 1 of the first embodiment, the antenna unit 1A has the detector 12 connected to the switch 5. The configuration that is identical with that of the antenna unit 1 shown in FIG. 1 is hereunder assigned the same reference numeral, and its detailed explanation is omitted.

The metallic plate 6 is used as a control antenna for controlling the gain of the loop antenna 2. As shown in FIG. 4, the metallic plate 6 is provided in the form of a loop within the same plane where the loop antenna exists, around the outside of the loop antenna 2. The metallic plate 6 is formed into the loop that becomes discontinuous at one location where open ends 6a are provided. The metallic plate 6 is formed into a two-turn rectangular loop from copper foil, or the like. According to the state of the switch 5 to be described later, the metallic plate effects a transition between a looped state where the metallic plate 6 is completely closed in the form of the loop and a non-looped state in which the metallic plate 6 becomes discontinuous at the open ends 3a and is not completely closed in the form of the loop.

The essential requirement for the metallic plate 6 is to be in substantially the same plane where the loop antenna 2 is present. In addition to being situated in the same plane as that made by the loop antenna 2, the metallic plate 6 can be provided while displaced by about one to two millimeters in the vertical direction from the plane. The switch 5 is interposed between the open ends 6a of the metallic plate 6, and the switch 5 is connected to an output side of the detector 12 shown in FIG. 4.

As will be described later, under control of the communication circuit section 4, the switch 5 effects a transition between the open state and the closed state according to the receiving level of the signal received by the loop antenna 2 detected by the detector 12. When the switch 5 is turned on and brought into a closed state, the open ends 6a of the metallic plate 6 are physically connected by way of the switch. Meanwhile, when the switch 5 is turned off and brought into an open state, the open ends 6a of the metallic plate 6 are physically disconnected. Therefore, when the switch 5 is closed, the open ends 6a of the metallic plate 6 are electrically connected by way of the switch 5. However, when the switch 5 is in the open state, the open ends 6a are not electrically connected.

When the switch 5 is closed, the switch 5 electrically connects the open ends 6a of the metallic plate 6, whereupon the metallic plate 6 assumes a looped state in which the metallic plate is closed in the form of a loop. Meanwhile, when the switch 5 is in an open state, the switch 5 does not electrically connect the open ends 6a of the metallic plate 6, so that the metallic plate 6 assumes a non-looped state in which the metallic plate 6 becomes discontinuous at the open ends 6a.

As in the case of the first embodiment, when the antenna unit 1A of the second embodiment performs wireless communication utilizing induction coupling, the switch 5 is turned off under control of the communication circuit section 4 according to the receiving level of the loop antenna 2 detected by the detector 12. When the metallic plate 6 is in a non-looped state in which the metallic plate 6 is discontinuous at the open ends 6a around the outside of the loop antenna 2, the S21 characteristic of the antenna unit 1A enables an increase in gain over the entire frequency band. Therefore, the antenna unit 1 can be applied to the antenna section of the mobile device even in response to a plurality of types of counterpart equipment that operate at different resonance frequencies.

As in the case of the first embodiment, when the antenna unit 1A of the second embodiment performs wireless communication utilizing induction coupling; for instance, when the receiving level of the loop antenna 2 detected by the detector 12 is higher than a given value (an amplitude is large), the switch 5 is turned on under control of the communication circuit section 4. When the metallic plate 6 is completely closed in the form of a loop around the outside of the loop antenna 2 by means of the switch 5, the gain of the antenna unit 1A can be reduced over the entire frequency band. Therefore, even when the antenna unit 1A of the embodiment is applied to the antenna section of the mobile device 10 in response to the antenna section of the counterpart equipment and when the mobile device 10 is used in a short range from the counterpart equipment, communication can be performed without involvement of occurrence of the Null phenomenon.

As in the case of the antenna unit 1A of the first embodiment. when the metallic plate 6 is provided in the form of a loop outside the loop antenna 2, an effect of reducing the S21 characteristic of a mobile device 20 becomes greater when compared with a case where the metallic plate 3 is provided in the form of a loop within the loop antenna 2.

### Third Embodiment

Incidentally, in the antenna unit 1 (1A) of each of the embodiments, the metallic plate 3 (the metallic plate 6) and the switch 5 make up a loop-shaped conductor. Therefore, the metallic plate 3 (the metallic plate 6) and the switch 5 can be caused to act as an antenna element. Put another way, in addition to having the loop antenna 2, the antenna unit 1 (1A) of each of the embodiments has a loop-shaped antenna built from the metallic plate 3 (the metallic plate 6) and the switch 5. Therefore, the antenna unit of the present invention can be applied to a mobile device equipped with a reader/writer function of the RFID system. In this case, the metallic plate 3 (the metallic plate 6) of the antenna unit of the present invention acts as an antenna for transmitting and receiving a wireless signal with respect to the counterpart equipment by means of induction coupling with the antenna of the counterpart equipment.

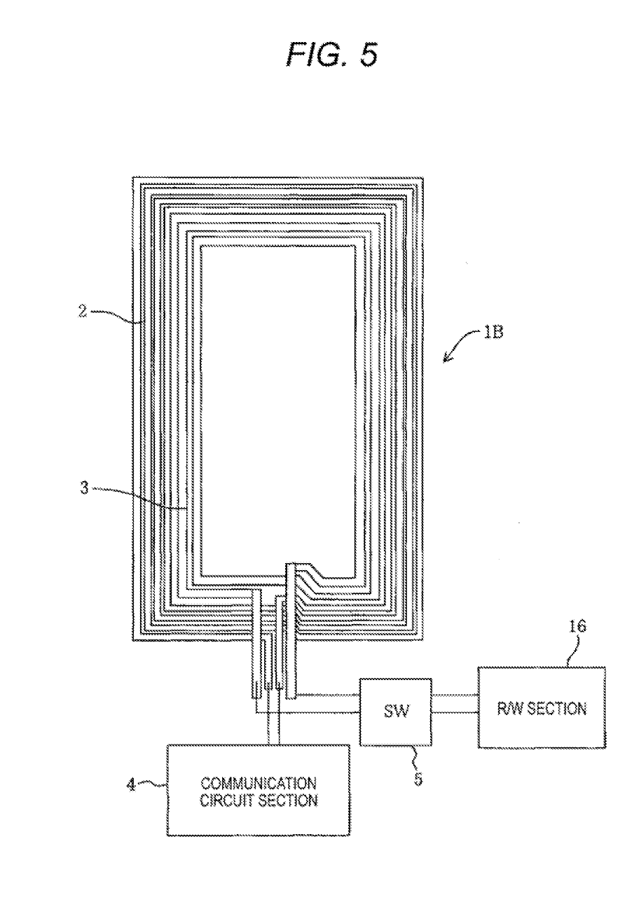

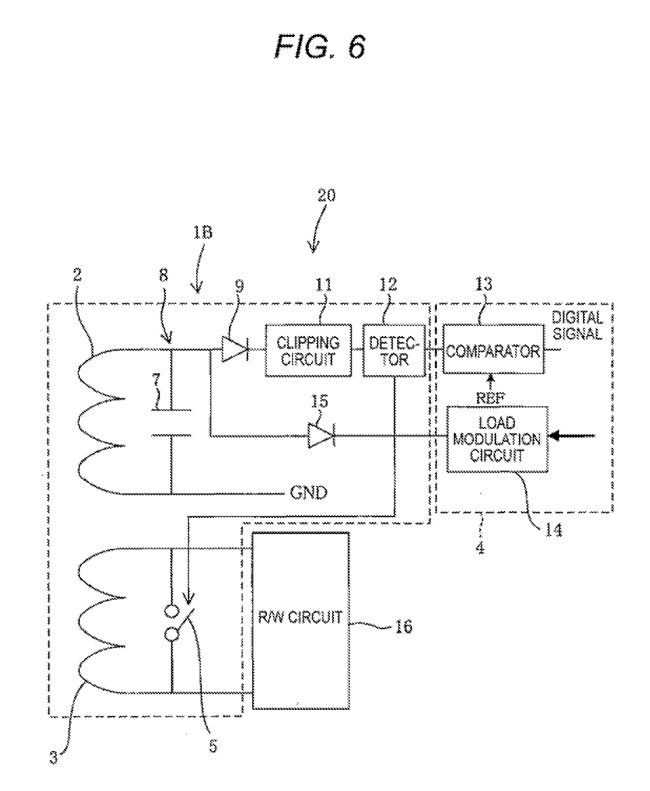

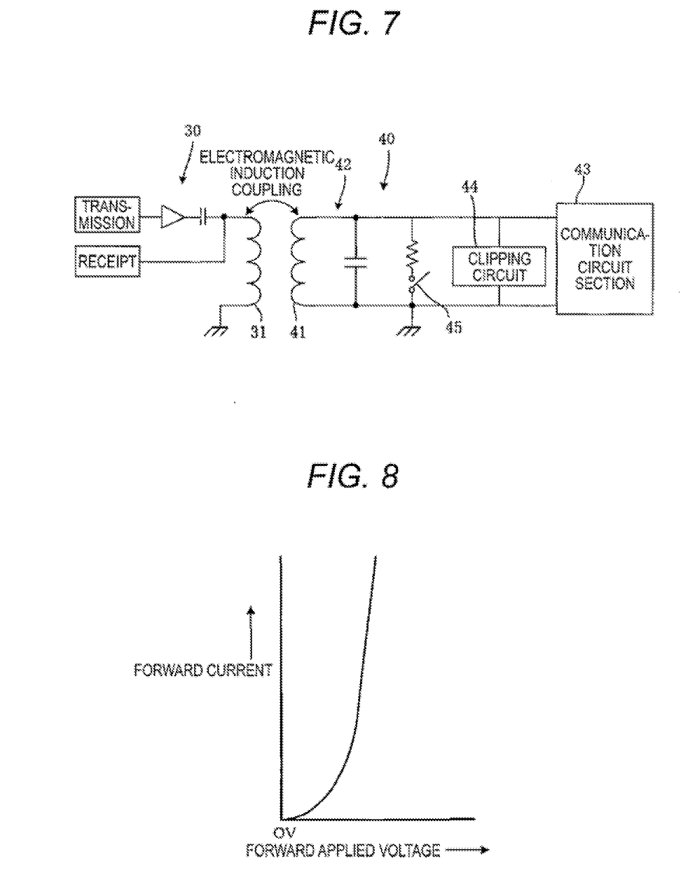

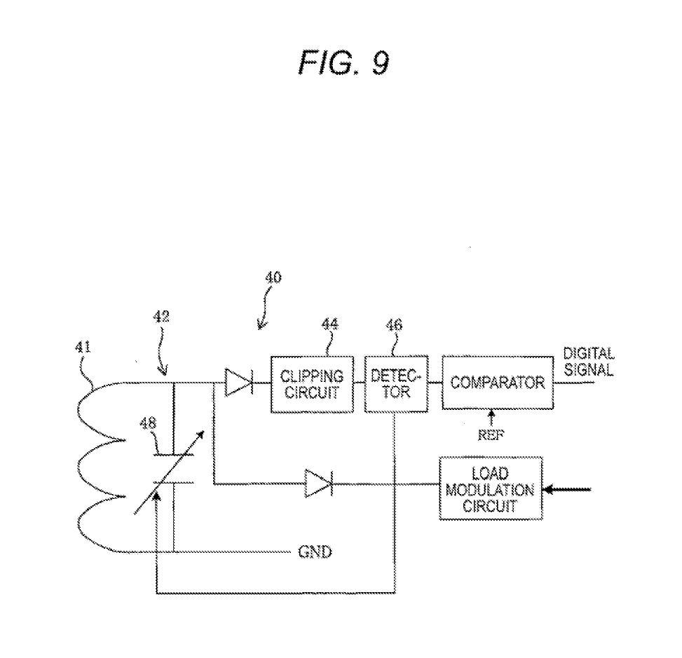

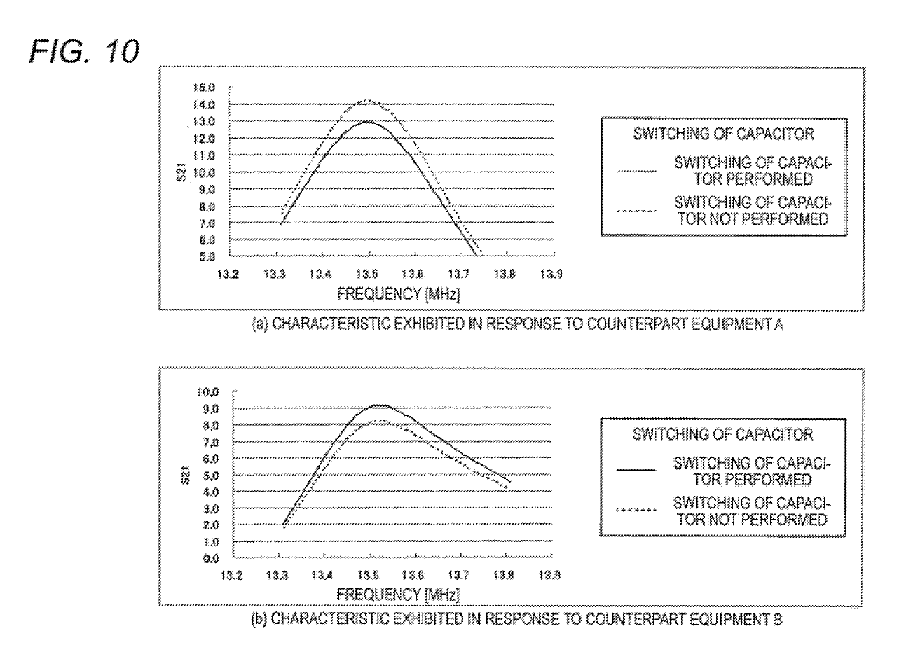

By reference to FIGS. 5 and 6, a description is now given to a case where the metallic plate of the present invention acts as the antenna unit of the third embodiment of the present invention for transmitting and receiving a wireless signal with respect to the counterpart equipment by means of induction coupling with the antenna of the counterpart equipment. FIG. 5 is a plan view showing an antenna unit 1B of the third embodiment of the present invention. FIG. 6 is a schematic diagram showing an equivalent circuit diagram of the mobile device 20 that is equipped with the antenna unit 1B and that exhibits a reader/writer function.

As in the antenna unit 1 shown in FIG. 1, a two-turn metallic plate 3 is provided inside the loop antenna 2 in the antenna unit 1B shown in FIG. 5, and the switch 5 interposed in the metallic plate 3 is connected to an output side of the detector 12. In the embodiment, a reader/writer section (R/W) 16 of the mobile device is connected to the switch 5. In other respects, the antenna unit 1B is structurally identical with the antenna unit 1 shown in FIG. 1.

The mobile device 20 shown in FIG. 6 has a reader/writer function. During a session of a communication using the loop antenna 2 that is a main antenna of the antenna unit 1B, the mobile device 20 does not use a control antenna made up of the metallic plate 3. When determined that the receiving level of the loop antenna 2 detected by the detector 12 comes to a given level or higher, the communication circuit section 4 controls the switch 5 so as to become activated, whereby the metallic plate 3 assumes a looped state in which the metallic plate 3 is completely closed in the form of a loop by means of the switch 5 around the inside of the loop antenna 2, thereby degrading the S21 characteristic of the loop antenna 2. Thereby, the switch 5 is turned on, to thus bring the metallic plate 3 into the looped state without involvement of occurrence of the Null phenomenon, whereby a gain of the antenna unit 1B can be reduced over the entire frequency band. Moreover, when the mobile device 20 performs communication with its counterpart equipment by means of the reader/writer function, the switch 5 is turned off by means of an output from the detector 12, to thus switch the metallic plate 3 to a non-looped state. Thus, the metallic plate 3 is used as an antenna for the reader/writer.

According to the antenna unit 1B of the present embodiment, the metallic plate 3 can also be used as a reader/writer antenna and an element for controlling a receiving level of the loop antenna 2. Hence, the mobile device 20 can also be miniaturized and made less expensive.

As in the first embodiment, when the antenna unit 1B of the present embodiment performs wireless communication utilizing induction coupling, the communication circuit section 4 controls the switch 5 so as to become deactivated according to the receiving level of the loop antenna 2 detected by the detector 12, whereupon the metallic plate 3 comes into a non-looped state in which the metallic plate 3 becomes discontinuous at the open ends 3a around the inside of the loop antenna 2. Therefore, the S21 characteristic of the antenna unit 1B enables the gain of the antenna unit to increase over the entire frequency band. Consequently, the antenna unit 1B can be applied to the antenna section of the mobile device 10 even in response to a plurality of types of counterpart equipment that operate at different resonance frequencies.

As in the first embodiment, in a case where the antenna unit 1B of the present embodiment performs wireless communication utilizing induction coupling, for instance, when the receiving level of the loop antenna 2 detected by the detector 12 is higher than a given value (an amplitude is large), the communication circuit section 4 controls the switch 5 so as to become activated, whereby the metallic plate 3 comes into the looped state where the metallic plate 3 becomes fully closed in the form of a loop by the switch 5 around the inside of the loop antenna 2. Thus, the gain of the antenna unit 1 can be reduced over the entire frequency band. Therefore, even when the antenna unit 1B of the present embodiment is applied to the antenna section of the mobile device 10 in response to the antenna section of the counterpart equipment and when the mobile device 10 is used in a short range from its counterpart equipment, communication can be performed without involvement of occurrence of a Null phenomenon.

Although the present invention has been described in detail by reference to the specific embodiments, it is manifest to those skilled in the art that the present invention be susceptible to various alterations or modifications without departing from the spirit and scope of the invention.

The present patent application is based on Japanese Patent Application (JP-2009-155294) filed on Jun. 30, 2009, the entire subject matter of which is incorporated herein by reference.

### INDUSTRIAL APPLICABILITY

The antenna unit of the present invention and the portable wireless device equipped with the same yield an advantage of the ability to establish wireless communication without involvement of occurrence of a Null phenomenon even when the mobile device has come close to its counterpart equipment, in response to a plurality of types of counterpart equipment that operate at different resonance frequencies. Hence, the antenna unit and the portable wireless device are useful as a cell phone, or the like.

### DESCRIPTIONS OF THE REFERENCE NUMERALS AND SYMBOLS

1, 1A, 1B ANTENNA UNIT
2 LOOP ANTENNA
3, 6 METALLIC PLATE
3a, 6a OPEN END
4 RESONANCE CIRCUIT
5 COMMUNICATION CIRCUIT SECTION
10, 20 MOBILE DEVICE
13, 13A LOWER ENCLOSURE BODY
12 DETECTOR
16 R/W SECTION

1. An antenna unit that performs wireless communication utilizing induction coupling, the unit comprising:
a loop antenna;
a communication circuit section that is connected to the loop antenna in order to perform wireless communication utilizing induction coupling;
a metallic plate provided outside or inside the loop antenna in a form of a loop by an openable and closable switch; and
a detector that detects a receiving level of a wireless signal received by the loop antenna;
wherein the communication circuit section controls opening and closing of the switch according to a receiving level of the wireless signal detected by the detector, thereby switching a state of the metallic plate between a closed looped state and an open non-looped state.

2. The antenna unit according to claim 1, wherein the metallic plate is provided on a same plane where the loop antenna is provided.

3. The antenna unit according to claim 1, wherein the metallic plate is a reader/writer antenna.

4. A portable wireless device comprising the antenna unit defined in claim 1.
